(19) United States
(12) Patent Application Publication
(10) Pub. No.: US 2026/0200791 A1
(43) Pub. Date: Jul. 16, 2026

(54) Infrared Reflective Tin Oxide Coatings and Methods of Making and Using the Same

(71) Applicant: GEMTRON CORPORATION, Sweetwater, TN (US)

(72) Inventors: Adam O'Ryan, Sweetwater, TN (US); Fangtong Xie, Mainz (DE); Karson Kimsey, Sweetwater, TN (US); Stephanie Mangold, Schornsheim (DE)

(21) Appl. No.: 19/136,645

(22) PCT Filed: Dec. 19, 2022
(86) PCT No.: PCT/US2022/053361

§ 371 Date: Jun. 6, 2025

(51) Int. Cl. C03C 17/25; F24C 15/04

(52) U.S. Cl. CPC C03C 17/253; F24C 15/04; C03C 2217/211; C03C 2217/244; C03C 2218/112

(57) ABSTRACT

An oven door glazing is formed of a SnO₂ coating doped with Sb and useful for coating substrates to provide reduced transmission of infrared radiation through the coated substrate over a broad range of infrared wavelengths.

### FIELD

The disclosure relates to infrared reflective coatings and more particularly to tin oxide-based coatings that are adapted to reflect and/or reduce infrared transmission through substrates, such as for use in oven glass.

### BACKGROUND

Infrared reflective coatings are conventionally pyrolytic organic coatings. They are widely used in cooking appliances, such as ovens, to reduce transmission of infrared radiation through the oven glass. Conventional pyrolytic infrared reflective coatings are organic coatings requiring the presence of a halogen, such as fluorine. As a result, coating processes are complex processes that require high temperatures. Such conventionally coated glass generally performs well only over portions of the wavelengths of infrared radiation, either short or long wavelength portions, but generally not both. This requires multiple different coatings or glass layers to be used. While some industrial methods use Sn, they are typically used as organic compounds, and need higher temperature for production. Such organic compounds are also expensive. Further, with conventional processes, the production process often results in residual carbon remaining, leading to haze after the substrate is coated.

### SUMMARY

An oven door glazing in accordance with the disclosure can include a SnO₂ coating doped with Sb formed on the substrate, wherein an average transmission of infrared wavelengths over a range of 800 nm to 1500 nm is less than 55%, preferably 50%, more preferably 45%, still more preferably 30%.

An oven door in accordance with the disclosure can include one or more glass substrates having the oven door glazing of the disclosure.

A method of forming an inorganic infrared reflective oven door glazing in accordance with the disclosure can include spray coating a substrate with a coating solution comprising an inorganic Sn precursor and an Sb doping precursor while heating the substrate to thereby form the oven door glazing comprising SnO₂ doped with Sb.

A method of forming an inorganic infrared reflective oven door glazing on a substrate in accordance with the disclosure can include coating a substrate with a coating solution comprising an Sn precursor and an Sb doping precursor, and heating the substrate to thereby form the inorganic oven door glazing comprising SnO₂ doped with Sb, wherein a ratio of an atomic percent of Sb to an atomic percent of Sn of 0.005 to 0.20.

A method of forming an infrared reflective oven door glazing with a darkening effect in accordance with the disclosure can include spray coating a coating solution comprising a Sn precursor and Sb dopant precursor onto a glass substrate while heating the substrate to a temperature of less than 500° C. to form the oven door glazing comprising Sn doped with Sb, wherein the oven door glazing has a dopant concentration such that a ratio of an atomic percent of Sb to an atomic percent of Sn is at least about 0.08.

### BRIEF DESCRIPTION OF THE DRAWINGS

FIG. 1 is a graph showing deposition rate for the various tested glazings.

FIG. 2 is a graph showing average transmission as a function of different doping as compared to uncoated soda lime glass and an undoped glazing.

FIG. 3 shows haze values for the glazings of FIG. 2.

FIG. 4 is a graph showing transmission over an infrared wavelength range for glazings doped with Sb as compared to uncoated and undoped samples.

FIG. 5 is a graph showing a transmission vs reflection for Sb doped glazings as compared to an undoped glazings.

FIG. 6 is a graph showing transmission over an infrared wavelength range for glazings doped with Ba as compared to uncoated and undoped samples.

FIG. 7 is a graph showing transmission over an infrared wavelength range for glazings doped with P as compared to uncoated and undoped samples.

FIG. 8 is a graph showing transmission over an infrared wavelength range for glazings doped with mixtures of dopants including Sb, P and/or Ba as compared to uncoated and undoped samples.

FIG. 9 is a comparison of transmission of a glazing in accordance with the disclosure to a conventional pyrolytic coating, where “Reference F doped SnO₂” is a conventionally fluorine doped SnO₂).

FIG. 10 is a graph showing the transmission of a conventional fluorine doped SnO₂ coating, illustrating that such conventional glazing have high transmission in the wavelength range of 800 nm to 1500 nm.

FIG. 11A is a schematic illustration of glass and glazing arrangement for a conventional F doped SnO₂ coatings used in an oven appliance.

FIGS. 11B and 11C are schematic illustrations of glass and glazing arrangements for glazings in accordance with the disclosure.

### DETAILED DESCRIPTION

Glazings of the disclosure are inorganic coatings capable of reducing infrared radiation transmission through the coated structure over a broad range of wavelengths, including both short and long wavelength infrared radiation, e.g., over the range of 800 nm to 1500 nm, while having improved reflecting in the range of 1500 nm to 4500 nm. The glazings of the disclosure are also referred to herein as coatings. Glazings of the disclosure are advantageously inorganic. In embodiments, coatings of the disclosure can be formed pyrolytically without requiring high temperature. The glazings of the disclosure are formed of Sb doped SnO₂. The glazings can be further doped with one or more additional dopants, such as P, Ba, Ni, and V. The coatings can be useful, for example, for coating glass used for cooking appliances, such as ovens, which require coated glass surface capable of reducing transmission of infrared radiation from the oven interior during use.

As compared to conventional coatings, the coatings of the disclosure have advantageously been found to have at least comparable performance if not improved performance, while allowing for the pyrolytic coating to be formed at significantly lower temperatures as compared to conventional pyrolytic coatings and/or reduced coating thicknesses as compared to conventional coatings.

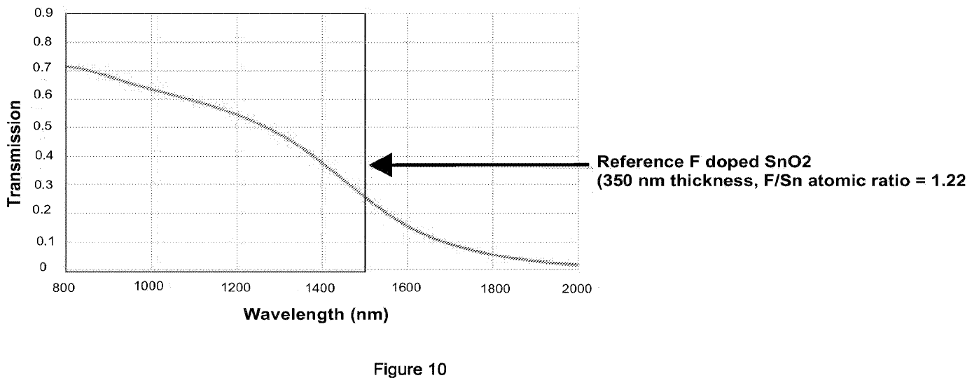

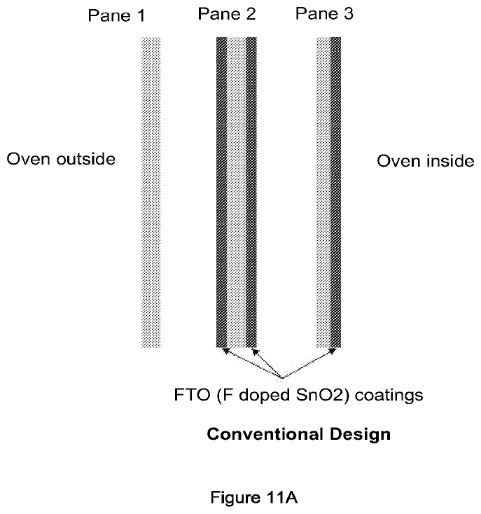

The glazings of disclosure, which include SnO₂ doped with one or more transition metals or metalloids were observed to reduce the average transmission of infrared radiation across the range of 800 nm to 1500 nm through the coated substrate to less than 55%, as measured by ISO 15365. For example, the average transmission of infrared radiation across of the range of 1500 nm to 2500 nm can be less than 70%, less than 50%, or less than 20%, as measured by ISO 15365. For example, the glazings of the disclosure can include SnO₂ doped with at least Sb. For example, glazings of the disclosure can have an average transmission over a range of 800 nm to 1500 nm of less than 65%. As shown in FIG. 9, the average transmission over a range of 800 nm to 1500 nm is lower than a substrate coated with a SnO₂ coating without doping for the same coating thickness, as well as for conventional fluorine doped SnO₂ coatings.

The glazings of the disclosure can have a thickness of about 100 nm to nm 600 nm, about 150 nm to about 300 nm, about 400 nm to about 500 nm, or about 200 nm to about 350 nm. Other suitable thicknesses include about 100, 110, 120, 130, 140,150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590 or 600 nm and any ranges or values there-between. Glazings of the disclosure can include multiple layers. Each of the coating layers can have a thickness of about 150 nm to about 500 nm

Cooking appliance glasses, such as used in oven doors, often include a number of differently coated layers of glass to provide various effects, such as darkening effect and reduction of infrared wavelength from the oven interior through the oven door glass. It has advantageously been found that the glazings of the disclosure can provide reduction of infrared transmission over a broader range of infrared wavelengths as compared to conventional coatings. Further, glazings of the disclosure can in some embodiments provide for a darkened or graying effect that is desirable in various applications. Reference will be made herein to a “darkening effect” and should be understood to refer to a glazing that reduces visible light transmission without a color effect. “Without color effect,” as used herein refers to color neutrality, as defined by a LAB color measurement absolute (a) of less than 20, absolute (b) less than 20. That is, the darkening effects darkens or provides a gray hue to the substrate surface as a result of the reduced visible light transmission. In conventional coated glass, the darkening or graying effect is typically provided by a layer of glass that does not have good infrared reflective properties. Glazings of the disclosure, in contrast, can advantageously provide for the graying or darkening effect while maintaining good infrared reflectively. It is also contemplated herewith that substrates can be coated with multiple coating layers either disposed on top of each other or on opposed sides of the substrate surface. One or more of the coating layers can be coatings in accordance with the disclosure. Optionally one or more of the coating layers can be conventional coatings, such as conventional darkening coatings. For example, a substrate can include a coating in accordance with the disclosure having dopant types and amounts selected to maximize reduction of infrared transmission, as well as include a coating in accordance with the disclosure having an amount of Sb dopant selected for imparting the darkening effect. The two coating layers can be disposed on top of one another or on opposed sides of the glass, thereby providing both improved infrared reflectivity and darkening effect.

A coated substrate having a darkening effect in accordance with the disclosure can include coating formed of SnO₂ doped with Sb such that an atomic percent ratio of Sb to Sn is at least about 0.02. For example, a coating having a darkening effect in accordance with the disclosure can have an atomic percent ratio of Sb to Sn of about 0.04. It was surprisingly found that the darkening effect was observed without scarifying the infrared reflectivity. In particular, the coating was found to allow for transmission of light having wavelengths in the visible spectrum, while maintaining reduced transmission of wavelengths across the infrared wavelength spectrum of 800 nm to 1500 nm. For example, the average transmission in the wavelength range of 800 to 1500 nm can be less than 55%, less than 50%, less than 45%, or less than 30%.

A coated substrate having a multilayer coating can include at least a first coating layer disposed on the substrate and a second coating layer disposed on the first coating layer. Any number of coating layers can be contemplated herein. Advantageously, because coatings of the disclosure can demonstrate good infrared reflectively at reduced thicknesses, multiple layer coatings can be provided without undesirable thickening of the substrate by the coating layers. The multilayer coating can have the first and second coating layers each being formed of SnO₂ doped with one or more of Sb, P, and Ba, but with the first and second coating layers being different in one or more of dopant concentration, dopant selection, and thickness. At least one of the first or second coating layer (or any coating layer of the multiple layer structure) can include Sb as the dopant to provide at least one layer with improved infrared reflectivity. It is also contemplated herein that coatings of the disclosure can be incorporated into multilayer coating structures with one or more conventional coatings.

The glazings of the disclosure are suitable for use in home appliances, such as cooking appliances surfaces, such as glass surfaces used in cooking appliances. For example, the cooking appliance glass can be oven door glass. As such, glazings of the disclosure can withstand temperatures of at least 550° C. without substantial degradation of the glazing. For example, coatings of the disclosure, when subjected to a temperature of 550° C. for 2 hours exhibited an increase in average transmission in the range of 800 nm to 1500 nm of not more than 5%. Glazings of the disclosure can advantageously allow for glass such as used in oven doors to be provided with a single sided coating and maintain or outperform the IR reflective performance of conventional double coated low-e glasses.

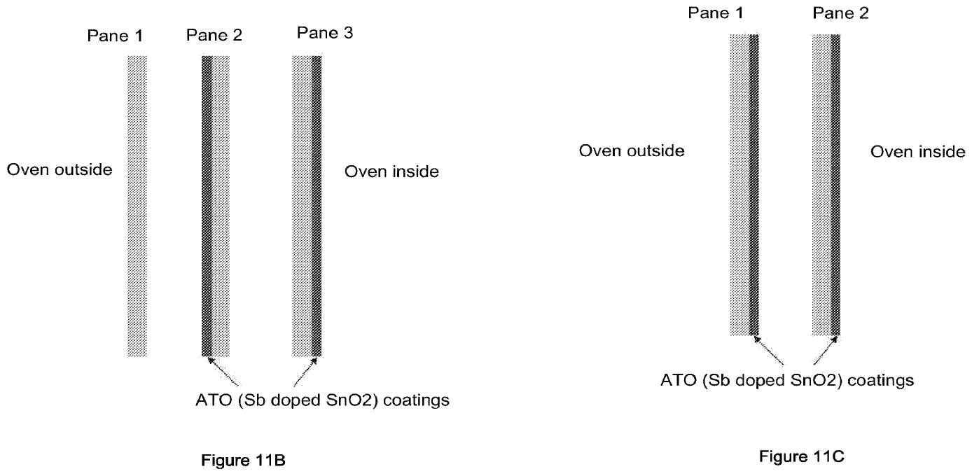

FIG. 11A illustrates a conventional arrangement of coated glass in an oven door. Typically, three coating layers are requires, as shown in FIG. 11A. By contrast, coatings in accordance with the disclosure can be used in arrangements such as shown FIGS. 11B and 11C, in which only two coatings are utilized. Further, as illustrated in FIG. 11C, the coatings of the disclosure can even allow for elimination of a pane of glass, for example, where the coating of the disclosure provides the darkening effect and the pane of glass for darkening effect is not needed.

The substrate to be coated can be glass. For example, the glass can be borosilicate glass, soda lime glass, or glass ceramic. As a benefit of the low pyrolytic formation temperatures of the coatings of the disclosure, the glass can be tempered or non-tempered. The coated glass substrates can be tempered after coating. The substrate can have any suitable thickness. For example, the substrate thickness can be about 3 mm to about 5 mm. Other substrate thicknesses are also contemplated herein.

The glazings of the disclosure are SnO₂ doped with at least Sb. The Sb can be present in the glazing in an amount such that a ratio of the atomic percent Sb to the atomic percent Sn (also referred to herein as an atomic percent ratio of Sb to Sn) is at least 0.005 relative to the atomic percent of Sn in the glazing. For example, the glazing can include, Sb in an amount such that the ratio is about 0.005 to about 0.20, about 0.02 to about 0.20, about 0.02 to 0.12, about 0.04 to about 0.08, about 0.03 to about 0.10, or about 0.05 to about 0.09. Other suitable values include about 0.005, 0.006, 0.007, 0.008, 0.009, 0.01, 0.02, 0.03, 0.04, 0.05, 0.06, 0.07, 0.08, 0.09, 0.10, 0.11, 0.12, 0.13, 0.14, 0.15, 0.16, 0.17, 0.18, 0.19, 0.20, and values and ranges defined there-between. Glazings of the disclosure intended for darkening effect can have Sb doping in an amount of such that an atomic percent ratio of Sb to Sn is about 0.02 to about 0.20, about 0.02 to about 0.08, about 0.04 to about 0.08. In multilayer coatings in which a coating layer is intended for darkening effect higher concentrations of Sb are contemplated herein, where another layer in the multilayer coating includes Sb in a concentration such that the atomic percent ratio of Sb to Sn is about 0.02 to about 0.2 for infrared reflectivity performance. It is also contemplated herein that such coating layers can be provided on opposed surfaces of the substrate instead of disposed on one another in a typical multilayer fashion.

The coated substrate of any one of the preceding claims, wherein the SnO₂ is further doped with any one or more of Ba, P, V, and Ni. Ba can be included in an amount such that an atomic percent ratio of Ba to Sn is up to about 0.09. P can be included in the glazing in an amount such that an atomic percent ratio of P to Sn is up to about 0.40. Ni can be included in the glazing in an amount such that an atomic percent ratio of Ni to Sn is less than 0.12. V can be including in the glazing relative in an amount such that an atomic percent ratio of V to Sn is less than 0.50.

The glazing can be substantially free of organic compounds. By substantially free of organic compounds, it is contemplated herein that the coatings may include residual amounts of organic solvent that remained from the coating solution. For example, the glazings of the disclosure can be free of residual carbon.

The glazings of the disclosure can be formed by spray coating a coating solution onto a heated substrate. Advantageously, the glazings of the disclosure can be formed at substrate temperatures of less than 650° C., for example, less than 550° C., for example less than 500° C. Any known spray coating equipment can be used. For example, ultrasonic or pressurized air spray coating equipment can be used. The spray coating can be performed with a medium droplet size of about 10 μm to about 100 μm.

The coating solution include a Sn precursor and a Sb doping precursor. The coating solution can further include one or more additional doping precursors to form a coating with one or more additional dopants selected from P, Ba, V, and Ni.

The precursor can be admixed or dissolved in a solvent. The solvent can be for example water and/or an alcohol. The alcohol can be, for example, ethanol, isopropanol, or butanol. The solvent can be a mixture of water and alcohol. It was observed that the haze resulting from the glazing was reduced when a mixture of water and alcohol was used as the solvent. For example, the solvent can be a 50/50 mixture of water and ethanol.

The Sn precursor can be an inorganic Sn salt. For example the Sn precursor can be SnCl₄ and/or SnCl. The Sn precursor can be provided in the coating solution in an amount of about 0.2 mol/L to about 3 mol/L, about 0.2 mol/L to about 0.5 mol/L about 1 mol/L to about 3 mol/L, or about 0.8 mol/l to about 1.5 mol/L. Other suitable amounts include about 0.2, 0.3, 0.4, 0.5, 0.6, 0.7, 0.8, 0.9, 1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, and values and ranges defined there-between.

The Sb doping precursor can be SbCl₃. The process of the disclosure can control the ratio of Sb³⁺ to Sb⁵⁺ through control over the atmosphere and/or concentration of the precursor. For example, using N₂ over O₂ or air will lead to more Sb³⁺. High concentrations of precursor will result in a high Sb³⁺:Sb⁵⁺ ratio. The Sb doping precursor is present in the coating solution in a concentration selected to provide the desired doping level in the coating. For example, the precursor can be provided in an amount to provide a doping level such that an atomic percent ratio of Sb to Sn is about 0.02 to about 0.20, about 0.02 to about 0.12, about 0.02 to about 0.08, or about 0.04 to about 0.12. The Sb doping precursor can be included in the coating solution in a concentration suitable to achieve any of the previously defined Sb doping amounts and significantly less than conventional F doping concentrations. Further, it was observed that the Sb dopant did not need to penetrate into the SnO₂ through the entire thickness to achieve good results. This can allow more flexibility in the concentration of Sb dopant used.

Methods of forming an infrared reflective inorganic glazing with a darkening effect include spray coating with a coating solution that includes the Sb doping precursor in an amount sufficient to provide a dopant level in the final concentration within the ranges described herein.

The coating solution can include a P doping precursor. The P doping precursor can be H₃PO₄, POCl₃, or PO(OEt)₃. The P doping precursor can be present in the coating solution at a concentration such that the coating is doped with P in an amount such that a ratio of an atomic percent of P to the atomic percent of Sn (also referred to herein as an atomic percent ratio of P to Sn) is up to 0.40.

The coating solution can include a Ba doping precursor. The Ba doping precursor is Ba(ac)₂, BaCl₂, or Ba(NO₃)₂. The Ba doping precursor can be present in the coating solution at a concentration such that the coating is doped with Ba in an amount such that a ratio of an atomic percent of Ba to the atomic percent of Sn (also referred to herein as an atomic percent ratio of Ba to Sn) is up to 0.09.

The coating solution can be substantially free of Sn or doping precursors containing organic compounds.

The coating solution can include additives, such as a pH modifier, oxidation additives, or reduction additives. The pH modifier can be 35% HCl. The oxidation additive can be H₂O₂. The reduction additive can be an amine or organic acids. Reduction additives can be used, for example, for VO₂ coating. Other additives can include denaturants, which are solvents with high boiling points. The denaturants can be used to further stabilize the tin compound(s). In an embodiment HNO₃ can be used to stabilize the tin compound, particularly when SbF(x) is used.

Methods of the disclosure can be used to form coatings one or both surfaces of the substrate to the coated. Methods of the disclosure can be used to form multilayer coating structures with coating layers formed disposed on one another. A multilayer coating can be formed by forming a first inorganic pyrolytic coating in accordance with the methods of the disclosure and subsequently spraying further coating solution onto the inorganic pyrolytic coating to form a further coating, the further coating solution comprising a Sn precursor and one or more dopant precursors comprising Sb, P, and Ba to form the further coating comprising SnO₂ doped with one or more of Sb, P, and Ba. The further coating can have a different concentration and/or type of dopant as compared to the inorganic pyrolytic coating on which it is formed. For example, the further coating or the first coating can be formed to provide the darkening effect with a coating solution having the Sb dopant precursor in an amount sufficient to provide a doped coating having an atomic percent ratio of Sb to Sn of at least 0.04. The other one of the coating can have a different amount of Sb and/or a combination of dopants to provide an improved infrared reflectivity of the substrate.

### EXAMPLES

Glazings in accordance with the disclosure were deposited on soda lime glass. The coatings included SnO₂ and one or more of Sb, P, and Ba as dopants. The dopant concentrations ranged from 2-8 at % Sb, 10-40 at % P, and/or 3-9 at % Ba relative to Sn in the coating. That is atomic percent ratios of Sb:Sn, P:Sn and Ba:Sn of 0.02 to 0.08, 0.10 to 0.40, and 0.03 to 0.09, respectively. The apparatus used a spray angle of about 22°, a shaping gas pressure of 0.1-0.2 bar, and a gas flow rate of 10 L/min. The glass was heated using a heat plate to a temperature of 430° C. during deposition. The nozzle was separated a distance of about 20 cm from the substrate. The coating solution included SnCl₄·5H₂O with a concentration of 0.43 mol/L to 0.5 mol/L. The solvent used in the coating solution was a 50%: 50% (vol %) H₂O/Ethanol mixture. The coating solution included one or more dopant precursors, selected from SbCl₃ (>99%), H₃PO₄, and Ba(ac)₂. The glazings had the following compositions:

| | Sb (at % | Ba (at % | P (at % |
|---|---|---|---|
| Sample | relative to Sn) | relative to Sn) | relative to Sn) |
| 1 (undoped) | — | — | — |
| 2 | 2 | — | — |
| 3 | 4 | — | — |
| 4 | 8 | — | — |
| 5 | — | 3 | — |
| 6 | — | 6 | — |
| 7 | — | 9 | — |
| 8 | — | — | 10 |
| 9 | — | — | 20 |
| 10 | — | — | 40 |
| 11 | 4 | — | 5 |
| 12 | 4 | 6 | — |
| 13 | — | 6 | 5 |

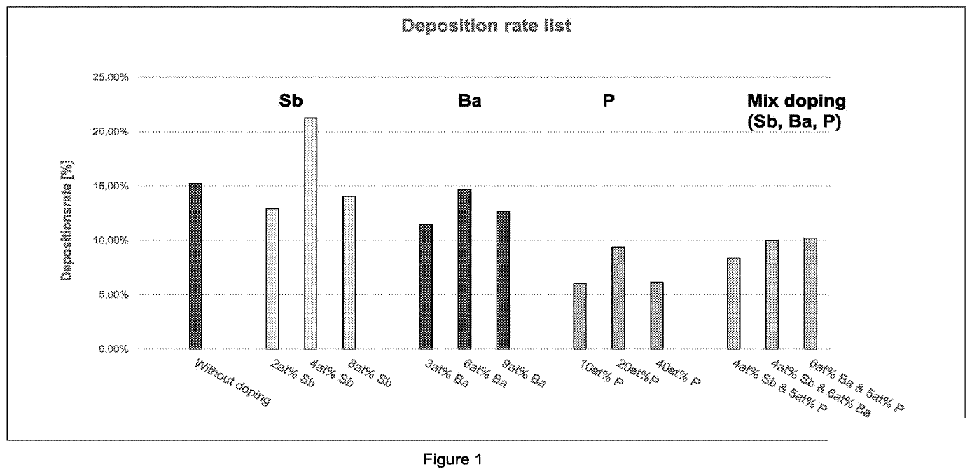

FIG. 1 shows the deposition rates as calculated from coating thickness for the deposited coatings.

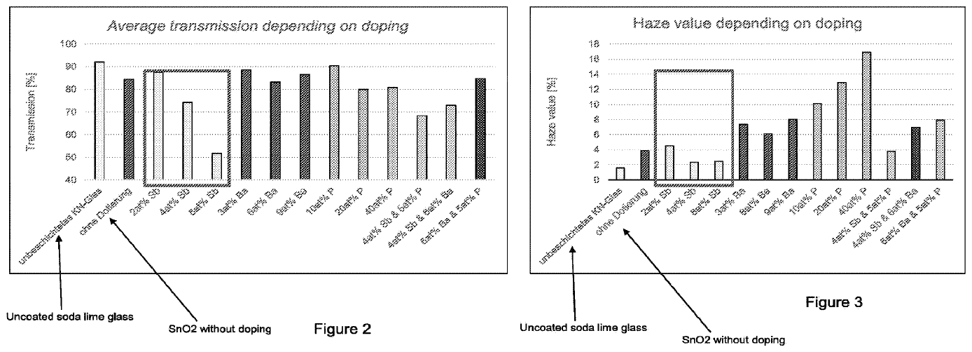

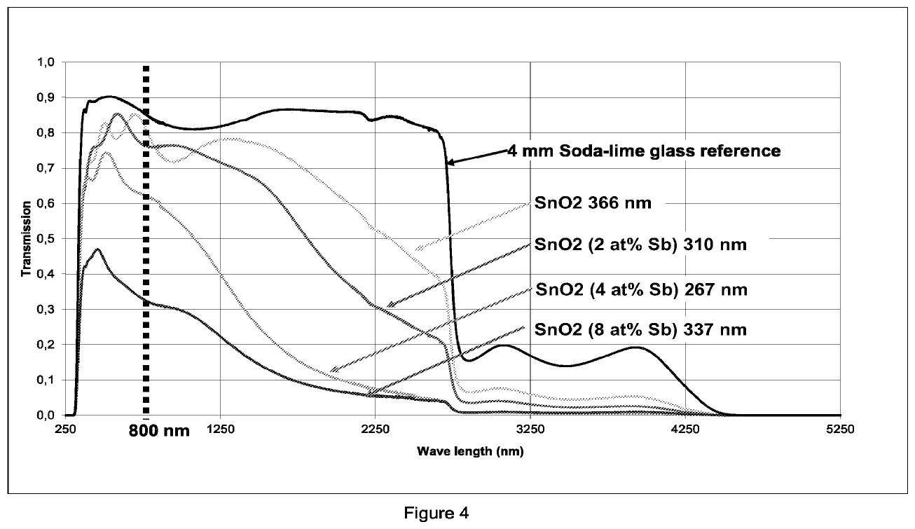

Average transmission of the various glazings was tested by ISO 15386. FIG. 2 shows the average transmission over the range of 400 nm to 700 nm for each of the glazings as well as a comparison to the uncoated glass. FIG. 3 shows the haze for each glazing as well as a comparison to the uncoated glass.

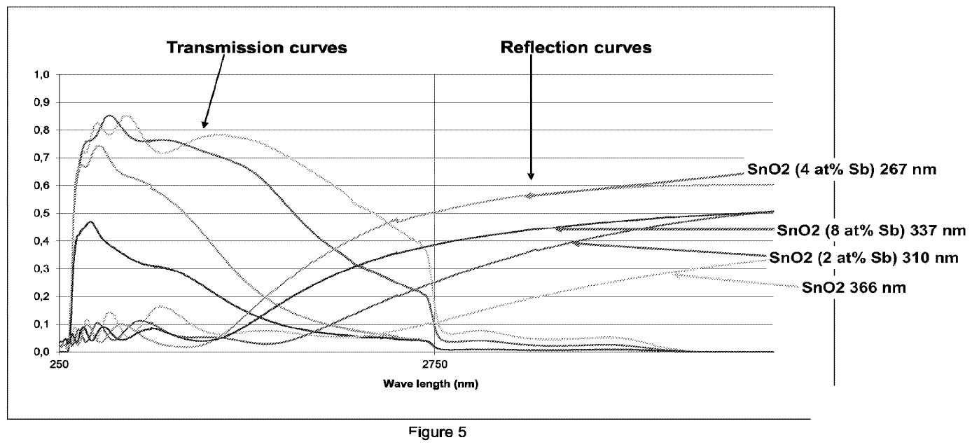

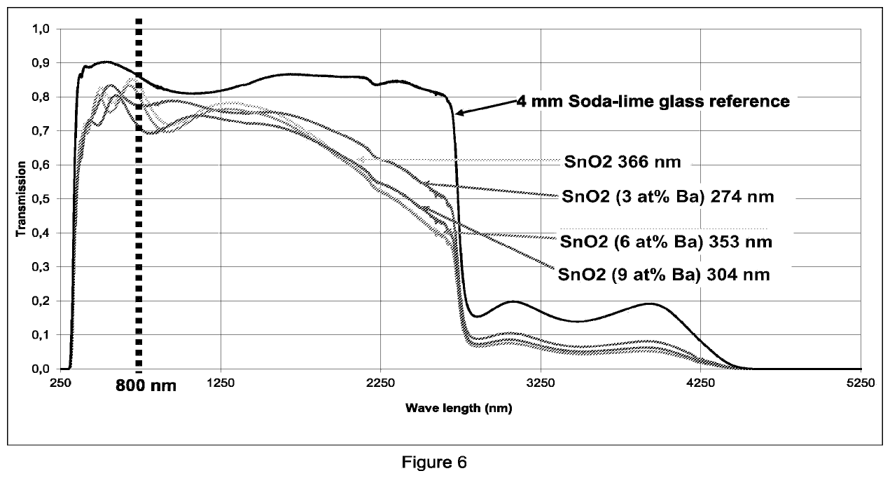

Referring to FIG. 4, it was observed that a SnO₂ coating, without doping, was able to reduce the average transmission over the range of 800 nm to 3000 nm as compared to the uncoated glass. Sb doping improved the reflectivity of the glazing, reducing the average transmission as compared to uncoated glass when present in an amount of 2 at % and further reducing the average transmission as compared to undoped SnO₂ coating. Significant reduction in the average transmission was observed with Sb present in an amount of 4 at % and 8 at %. FIG. 5 shows reflection vs transmission for the SnO₂ Sb doped glazings. It was observed that the reflection was dependent on Sb concentration, with 4 at % Sb resulting in better reflection than 2 at % Sb.

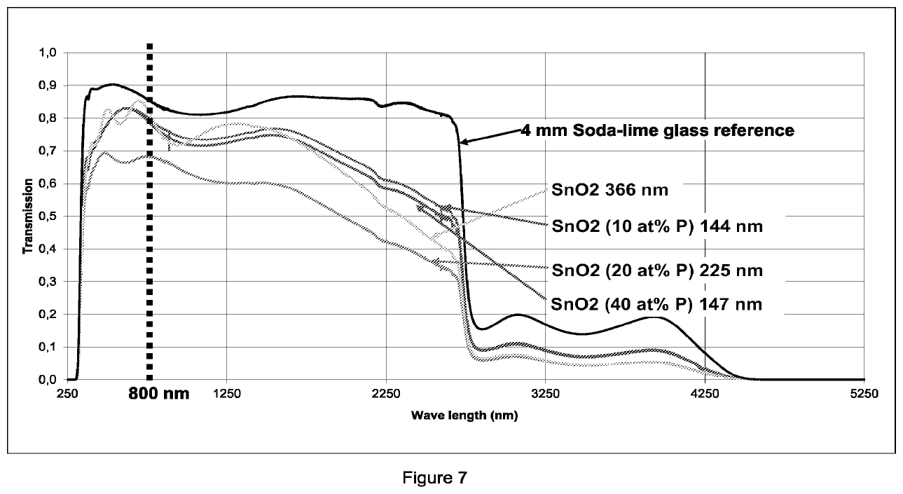

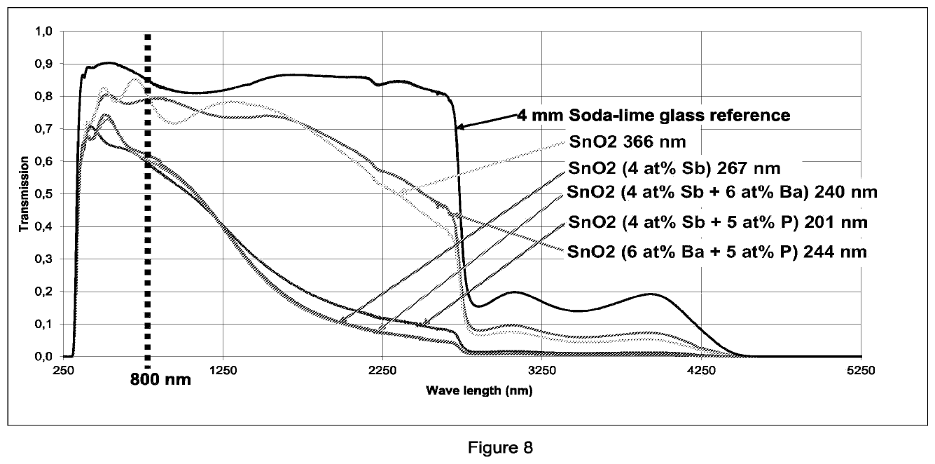

Referring to FIG. 6, Ba doping was found to reduce the average transmission as compared to the uncoated glass. However, relatively similar performance was observed relative to the undoped SnO₂ sample. Referring to FIG. 7, P doping in high atomic percent (above 10 at %) were observed to have some reduction of transmission relative to the uncoated sample as well as the SnO₂ undoped coating. Further, it was observed that the glazing of the disclosure could allowed for reduction of the thickness of the coating without sacrificing performance.

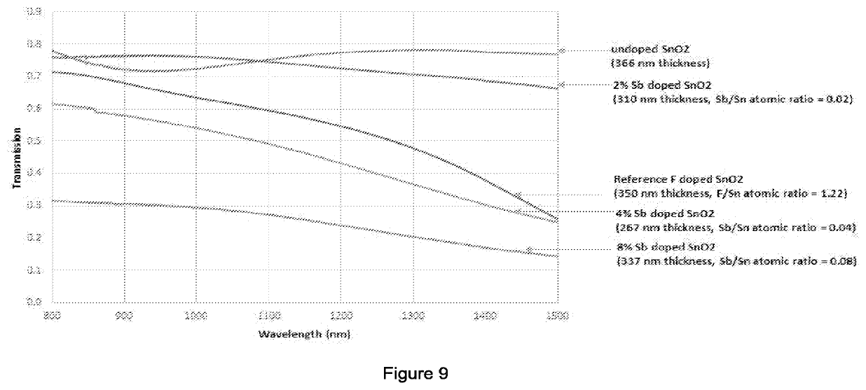

Referring to FIG. 8, mixed doped coatings including Sb and P or Sb and Ba were observed to have improved performance as compared to the uncoated glass, the SnO₂ undoped sample, and the samples having the equivalent amount of Sb. The combination of Ba and P dopant was found not to have a significant effect on transmission as compared to use of Ba or P alone.

FIG. 9 shows a performance comparison of the 4% Sb doped SnO₂ coating in accordance with the disclosure to a conventional fluorine doped SnO₂ coating having a thickness of 350 nm and a F/Sn atomic ratio of 1.22. The coating in accordance with the disclosure showed comparable performance to the conventional coating. However, the coating of the disclosure can advantageously be made as a pyrolytic coating without the need for high temperatures typically required. This can be beneficial in allowing for broader use of the coatings on various types of substrates, as well as reducing complexity and improving efficiency of coating processes.

At doping levels above 2 at % Sb, the glazing provided a graying or darkening effect, which could be desirable in various applications. CIELAB color space measurements are shown in the table below. Measurements were performed in accordance with ASTM E313

| Sb % (Sb/Sn | Coating | | | |
|---|---|---|---|---|
| atomic ratio) | thickness (nm) | L* | A* | B* |
| 2% | 310 | 32.36 | −4.63 | −5.42 |
| 4% | 267 | 34.44 | 13 | −7.98 |
| 8% | 337 | 35.14 | −4.02 | 3.97 |

Significant graying was observed at 8 at % Sb. These samples also demonstrated good reflectivity of the infrared radiation over a broad wavelength range as discussed above. The glazing of the disclosure, thus, surprisingly and beneficially achieved a darkening effect on glass without sacrificing IR reflectivity performance.

The foregoing description is given for clearness of understanding only, and no unnecessary limitations should be understood therefrom, as modifications within the scope of the disclosure may be apparent to those having ordinary skill in the art.

All patents, patent applications, government publications, government regulations, and literature references cited in this specification are hereby incorporated herein by reference in their entirety. In the case of conflict, the present description, including definitions, will control.

Throughout the specification, where the compounds, compositions, methods, and/or processes are described as including components, steps, or materials, it is contemplated that the compounds, compositions, methods, and/or processes can also comprise, consist essentially of, or consist of any combination of the recited components or materials, unless described otherwise. Component concentrations can be expressed in terms of weight concentrations, unless specifically indicated otherwise. Combinations of components are contemplated to include homogeneous and/or heterogeneous mixtures, as would be understood by a person of ordinary skill in the art in view of the foregoing disclosure.

1. An oven door glazing, comprising a SnO₂ coating doped with Sb formed on the substrate, wherein an average transmission of infrared wavelengths over a range of 800 nm to 1500 nm is less than 55%.

2. The oven door glazing of claim 1, wherein a ratio of an atomic percent Sb to an atomic percent Sn is 0.005 to 0.20.

3. (canceled)

4. An oven door glazing having a darkening effect, comprising a SnO₂ coating doped with Sb formed on the substrate, wherein a ratio of an atomic percent Sb to an atomic percent of Sn is 0.02 to 0.20, the coating has transmission of light having wavelengths in the visible spectrum of less than 80% while maintaining a transmission of infrared wavelengths in a range of 800 nm to 1500 nm of less than 55%.

5. The oven glazing of claim 4, wherein the coating has a color neutrality absolute value of (a)<20 and absolute (b)<20, as measured by ASTM E313.

6. An oven door glazing comprising at least a first coating layer disposed on the substrate and a second coating layer disposed on the first coating layer, wherein the first and second coating layers each comprise SnO₂ doped with one or more of Sb, P, and Ba, the first and second coating layers different in one or more of dopant concentration, dopant selection, and thickness, and at least one of the first or second coating layer comprises Sb as a dopant.

7. The oven door glazing of claim 1, wherein the coated substrate is adapted to withstand temperatures of 550° C. for at least 2 hours with an increase in transmission over the wavelength of 800 nm to 1500 nm of no more than 5%.

8. The oven door glazing of claim 1, wherein the substrate is glass.

9. The oven door glazing of claim 7, wherein the glass is cooking appliance glass, optionally wherein the cooking appliance glass is for oven door glass.

10. (canceled)

11. The oven door glazing of claim 1, wherein the coating has a thickness of about 150 nm to about 600 nm.

12. The oven door glazing of claim 1, wherein the SnO₂ coating is further doped with one or both of Ba and P.

13. The oven door glazing of claim 12, wherein the Ba dopant is present in an amount such that a ratio of an atomic percent of Ba to an atomic percent of Sn is up to about 0.09 and/or wherein the P is present in an amount such that a ratio of an atomic percent of P to an atomic percent of P is up to about 0.40.

14. (canceled)

15. The oven door glazing of claim 1, wherein the coating is substantially free of organic compounds.

16. An oven door comprising the oven door glazing according to claim 1.

17. A method of forming an inorganic infrared reflective oven door glazing, comprising: spray coating a substrate with a coating solution comprising an inorganic Sn precursor and an Sb doping precursor while heating the substrate to thereby form the oven door glazing comprising SnO₂ doped with Sb; or
comprising coating a substrate with a coating solution comprising an Sn precursor and an Sb doping precursor, and heating the substrate to thereby form the inorganic oven door glazing comprising SnO₂ doped with Sb, wherein a ratio of an atomic percent of Sb to an atomic percent of Sn of 0.005 to 0.20.

18. (canceled)

19. A method of forming an infrared reflective oven door glazing with a darkening effect, comprising:
spray coating a coating solution comprising a Sn precursor and Sb dopant precursor onto a glass substrate while heating the substrate to a temperature of less than 500° C. to form the oven door glazing comprising Sn doped with Sb, wherein the oven door glazing has a dopant concentration such that a ratio of an atomic percent of Sb to an atomic percent of Sn is at least about 0.08.

20. The method of claim 17, wherein the substrate is heated to a temperature of less than 650° C.

21. The method of claim 17, wherein the Sb doping precursor is SbCl₃ and/or wherein the Sb doping precursor is present in the coating solution in a concentration such that Sb present in the oven door glazing in an amount such that the ratio is about 0.02 to about 0.12.

22. (canceled)

23. (canceled)

24. (canceled)

25. The method of claim 17, wherein the coating solution comprises one or more further doping precursors for doping the SnO₂ oven door glazing with one or more of P, Ba, V, and Ni.

26. The method of claim 25, wherein the coating solution further comprising a P doping precursor, optionally selected from H₃PO₄, POCl₃, or PO(OEt)₃; and/or wherein the coating solution further comprising a Ba doping precursor, optionally selected from Ba(ac)₂, BaCl₂, or Ba(NO₃).

27. (canceled)

28. The method of claim 26, wherein the P doping precursor is present such that the oven door glazing is doped with P in an amount such that a ratio of an atomic percent of P to the atomic percent of Sn is up to 0.40; and/or wherein the Ba doping precursor is present such that the coating is doped with Ba in an amount such that a ratio of an atomic percent of Ba to the atomic percent of Sn is of up to 0.09.

29. (canceled)

30. (canceled)

31. (canceled)

32. (canceled)

33. The method of claim 17, wherein the Sn precursor is present in the coating solution in an amount of about 0.2 mol/L to about 3 mol/L; and optionally wherein the Sn precursor comprises SnCl₄ and/or SnCl₂.

34. The method of claim 17, wherein the coating solution comprises a solvent and/or a pH modifier.

35. (canceled)

36. (canceled)

37. (canceled)

38. (canceled)

39. The method of claim 17, wherein the substrate is tempered glass or wherein the substrate is non-tempered glass and the method further comprises tempering the glass after coating with the inorganic pyrolytic coating.

40. (canceled)

41. (canceled)

42. (canceled)

43. (canceled)

44. (canceled)

45. The method of claim 17, further comprising spray coating a further coating solution onto the inorganic pyrolytic coating to form a further coating, the coating solution comprising a Sn precursor and one or more dopant precursors comprising Sb, P, and Ba to form the further coating comprising SnO₂ doped with one or more of Sb, P, and Ba, wherein the further coating has a different concentration and/or type of dopant as compared to the inorganic pyrolytic coating on which it is formed.

46. The method of claim 45, wherein the further coating comprises an Sb dopant precursor in an amount such that the further coating comprises Sb in an amount such that a ratio of an atomic percent of Sb to the atomic percent of Sn is at least 0.08 and the further coating provides a darkening effect.

47. (canceled)
